(19) United States
(12) Patent Application Publication
(10) Pub. No.: US 2015/0108142 A1
(43) Pub. Date: Apr. 23, 2015

(54) Cooking Pot

(71) Applicant: Quantum Technologie (Deutschland) GmbH, Puchheim (DE)

(72) Inventor: Ki CHAN, Wanchai (HK)

(21) Appl. No.: 14/579,332

(22) Filed: Dec. 22, 2014

Related U.S. Application Data
(63) Continuation of application No. PCT/EP2013/062294, filed on Jun. 13, 2013.

(30) Foreign Application Priority Data
Jun. 22, 2012 (EP) 12173280.4

(51) Int. Cl. A47J 36/02; C09D 1/00; C08K 3/22; B05D 1/26

(52) U.S. Cl. CPC A47J 36/02; B05D 1/26; C09D 1/00; C08K 3/22; C08K 2003/2289; C08K 2003/2251; C08K 2003/2206
USPC 220/573.1; 427/238; 106/286.2

(57) ABSTRACT

A cooking pot with an enhanced bottom provides an enhanced heat transport from the cooking plate to the food inside the cooking pot. The bottom of the cooking pot has a hollow compartment being evacuated and coated with a blend of inorganic compounds.

### PRIORITY CLAIM

This application is a continuation of pending International Application No. PCT/EP2013/062294 filed on 13 Jun. 2013, which designates the United States and claims priority from European Application No. 12173280.4 filed on Jun. 22, 2012, both of which are incorporated by reference in their entireties.

### BACKGROUND OF THE INVENTION

1. Field of the Invention

The invention relates to a cooking pot.

2. Description of Relevant Art

Cooking pots are commonly used for cooking and/or frying of food. Cooking pots have in most cases a bottom being surrounded by ring like wall structure. In some cases a lid may be positioned on top of the wall structure, closing the cooking pot. When cooking heat from a heat source, typically a cooking plate has to be transferred via the bottom to the food, e.g. a soup, vegetables or meat, inside the cooking pot. In particular if used on an electrical cooking plate it is essential that the lower side, i.e. the cooking plate surface of the cooking pot remains planar, to provide good thermal contact between the cooking plate and the cooking pot. However, due to thermal stress the bottom of a cooking pot tends to bend like a dome (or an inverted dome) and accordingly the thermal contact between the cooking pot and the cooking plate is reduced. To reduce this bending, sandwich bottoms have been suggested. The layers of the bottom have been chosen on the one hand to provide a good thermal conductivity, e.g. by using copper or aluminum layers. Stability has been accounted for by steel, in particular stainless steel layers. In most cases the stainless steel layers form the two boundary layers of the sandwich bot-tom. The layers have been combined, such that the bending forces of the different layers compensate each other. A method for combining different layers to a sandwich bottom of a cooking pot is disclosed in EP 2 468 156A1

US 2013/056474A1 discloses a cooking pot with a bottom to which a double layer wall structure is attached. The space between the two layers of the double layer wall structure is evacuated to reduce energy transfer from inside the cooking pot to its surrounding.

Qu reports in the US-patent application U.S. Pat. No. 6,132,823 a hollow rod like heat conduction constructional element having an extremely high thermal conductivity. The interior of the rod is coated with three basic layers, the first layer being a combination of sodium, beryllium, a metal such as manganese or aluminum, calcium, boron and dichromate radical; the second layer formed over the first layer and being a combination of cobalt, manganese, beryllium, strontium, rhodium, copper, 13-titanium, potassium, boron, calcium, a metal such as manganese or aluminum and the dichromate radical; and the third layer formed over the second layer and being a combination of rhodium oxide, potassium dichromate, radium oxide, sodium dichromate, silver dichromate, monocrystalline silicon, beryllium oxide, strontium chromate, boron oxide, 13-titanium and a metal dichromate, such as manganese dichromate or aluminum dichromate. A theoretical understanding for the extremely well heat conductivity of the heat conduction constructional element was not obtained yet.

### SUMMARY OF THE INVENTION

The embodiments are based on the object of providing a cooking pot having an improved heat transfer between the cooking plate facing side and the up facing side of its bottom.

The invention is based on the observation that the coating according to Qu's method imposes difficulties as there is an incompatibility between the typical cooking pot material (stainless steel) which is to be coated and the coating layers.

The cooking pot has as usual a bottom, to which a wall structure is attached. The wall structure encloses a space above the bottom. Food may be put into the space for heating it. Different from the prior art cooking pots the bottom of the cooking pot according to the invention preferably has a hollow evacuated compartment. Evacuated means here that the pressure inside the hollow compartment is lower than ambient pressure and preferably lower than 104 Pa. Preferably, the inner surfaces enclosing the compartment are coated with inorganic compounds to thereby obtain an optimized heat transfer.

For coating, an aqueous solution of several inorganic salts may be inserted into the compartment. The aqueous solution is also referred to a coating liquid. Subsequently the compartment may be evacuated and closed, i.e. so to speak sealed and preferably heated.

The aqueous solution may preferably comprise (per 100 ml of water (H₂O)) at least one of the following groups of ingredients:

| | | |
|---|---|---|
| Ingredients | Formula | Amount |

List 1
I. First group of ingredients (List 1):

| | | | | |
|---|---|---|---|---|
| 1 | Sodium peroxide | Na₂O₂ | 0.12 | g |
| 2 | Beryllium oxide | BeO | 0.01 | g |
| 3 | Potassium | K₂Cr₂O₇ | 0.2 | g |
| | dichromate | | | |
| 4 | Calcium dichromate | CaCr₂O₇•3H₂O | 0.2 | g |
| 5 | Boron oxide | B₂O₃ | 0.1 | g |

List 2
II. Second group of ingredients (List 2)

| | | | | |
|---|---|---|---|---|
| 6 | Cobaltous oxide | Co₂O₃ | 0.001 | g |
| 7 | Strontium chromate | SrCrO₄ | 0.1 | g |
| 8 | Potassium | K₂Cr₂O₇ | 0.6 | g |
| | dichromate | | | |

III. Third group of ingredients (List 3)

| | | | | |
|---|---|---|---|---|
| 9 | Sodium dichromate | Na₂Cr₂O₇ | 0.2 | g |
| 10 | Silver dichromate | Ag₂Cr₂O₇ | 0.001 | g |

| | | | |
|---|---|---|---|
| 11 | Potassium | K₂Cr₂O₇ | 0.6 g-0.8 g |
| | dichromate | | |

An example for preparing a coating liquid, i.e. an aqueous solution for subsequent coating of the hollow compartment of the cooking pot is set out below:
1. Dissolve in the given order and one after the other the ingredients of list 1 in the given amount in preferably ultra pure water (resistivity preferably ρ≧18.2 MΩ cm at 25° C.). Use for example an Erlenmeyer conical flask. After adding each ingredient to the water, stir the water for at least 10 min.
2. After adding all ingredients of list 1, keep stirring for at least 30 min.
3. Dissolve in the given order and amount and one after the other the ingredients of list 2 into the solution. After adding each ingredient to the water, stir the water for at least 5 min.
4. Dissolve the ingredients of list 3 one after the other in the given amount and order to the solution under permanent stirring. After dissolving the ingredients, keep stirring for at least 40 min.
5. Store the obtained solution, subsequently referred to as coating solution, in an airtight sealed container under ambient temperature (temperature 5-30° C.). Avoid contact of the liquid to air and in particular to oxygen.

The such obtained aqueous solution may be used for coating the hollow compartment as set out below:
1. Prepare the compartment inside the cooking pot's bottom made of a metal like aluminum, stainless steel (e.g. material number 1.4301/composition: X5CrNi18-10 or material number 1.4404/composition X2CrNiMo17-12-2) or carbon steel, such that is cleaned from dust, oxides oil and the like. This can be accomplished for example by first cleaning disc like layers, being spaced by an as well cleaned ring like spacer, and subsequently weld or bond the disc like layers and the spacer to form a disk like bottom. Thus one obtains a closed hollow compartment inside the cooking pot's bottom.
2. Prepare at least one injection opening having for example a diameter of e.g. about 3 to 8 mm. The diameter can vary (e.g. 1 mm to 5 cm) dependent on the volume of the compartment being enclosed by the inner surface and the size of the inner surface. The injection opening is preferably prepared before cleaning the inner surface and before closing the profile, to avoid that drilling chips reside inside the intermediate product. The injection opening can be drilled for example into the spacer before the cleaning step.
3. An injection pipe may be connected to the opening by e.g. welding or bonding.
4. Evacuate the compartment, i.e. the compartment to a pressure of about 10⁴ Pa or lower. To this end a vacuum pump can be connected to the pipe. Now the pump and the compartment are in fluid communication. After the evacuation of the space, the pump can be disconnected from the pipe.
5. Inject the coating liquid prepared as explained above into the compartment, for example via the pipe. The volume of the injected liquid should be between 1000 ml and 800 ml per m² of the surface of the compartment. For example using a cylindrical bottom with diameter of 30 cm and height of 1 cm has an inner surface of about 0.865 m². One should thus insert between 865 ml and 692 ml of the aqueous solution. To this end one may use an injector being connected to the pipe. The pipe may preferably be connected to a valve. A very simple, but efficient possibility is to connect a rubber hose to the pipe and clamp it to keep the vacuum. The injector may be coupled to the rubber hose and the clamp can be opened. Thereby, the coating liquid is drawn into the compartment due to the low pressure inside the compartment.
6. After inserting the coating liquid, one may optionally evacuate the compartment again to at least about 10⁴ Pa.
7. Seal the injection opening preferably permanently, for example by clamping the root of the pipe using mechanical tools which may be actuated hydraulically or pneumatically. One may close the whole as well by welding.

When first heating the such prepared thermal conductor, the liquid inside the compartment coats the surface of the compartment.

### BRIEF DESCRIPTION OF THE DRAWINGS

In the following, the invention will be described by way of example, without limitation of the general inventive concept, on examples of embodiment and with reference to the drawings.

FIG. 1 is a flow diagram explaining preparation of the coating liquid.

FIG. 2 is a flow diagram illustrating the method for manufacturing the cook-ing pot.

FIG. 3 is a sketch of a cooking pot according to the invention.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENT

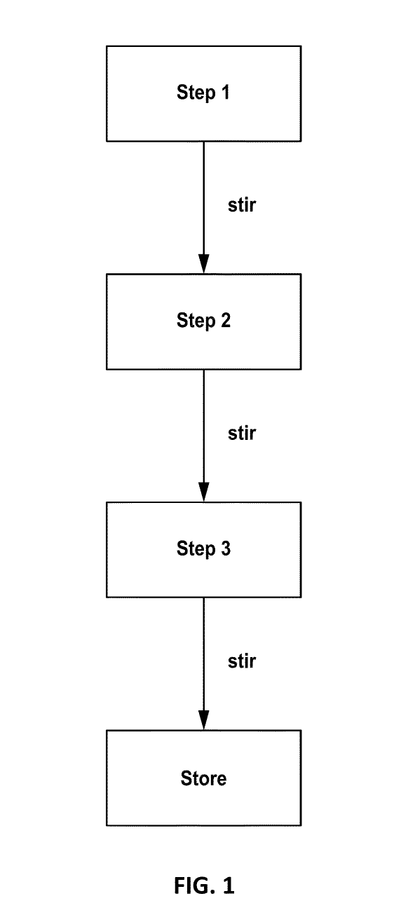

An example for preparing a coating liquid is explained with respect to FIG. 1. In a first step (Step 1), 100 ml of ultra pure water (resistivity preferably ρ≧18.2 MΩ cm at 25° C.) is filled in an Erlenmeyer conical flask at standard laboratory conditions. Subsequently the chemicals (ingredients) as listed in List 1 are dissolved under stirring one after the other in the given order as listed and in the given amounts. After having inserted a chemical and before insertion of the subsequent chemical of List 1 the solution is stirred for at least 10 min.

Subsequently the obtained solution is further stirred for about 30 min.

In Step 2, the chemicals (ingredients) as listed in List 2 are dissolved under stirring one after the other in the given order as listed and in the given amounts. After having inserted a chemical and before insertion of the subsequent chemical of List 1 the solution is stirred for at least 5 min.

In the next step (Step 3), the chemical as listed in List 3 are dissolved in the given order under continuous stirring in the given amounts.

In the last step the flask is sealed and the coating liquid can be stored an ambient conditions (5° C.≧T≧30° C.).

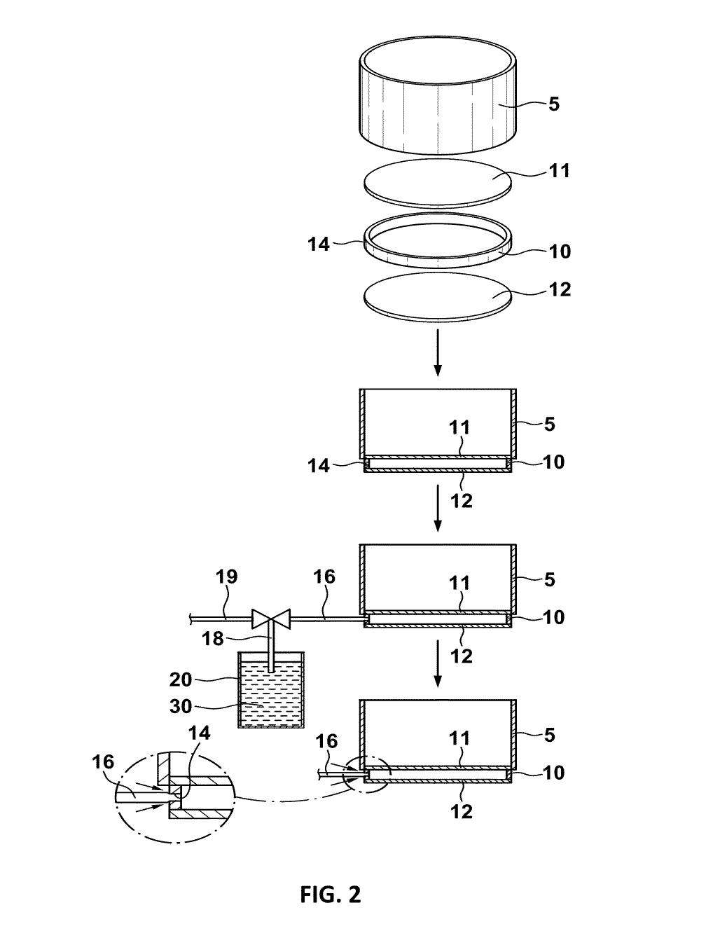

The procedure of manufacturing a heat conductor using the coating liquid as prepared according to the above example is explained with respect to FIG. 2.

The procedure starts with assembly of the bottom of the later cooking pot. First the an upper disc 11 a lower disc 12, and a ring like spacer 10, all e.g. of stainless steel are cleaned. The spacer 10 may have a whole 14 to which an injection pipe 16 may be attached. After cleaning, the two disks 11, 12 and the spacer 10 may be assembled and fixed to each other by e.g. welding or bonding, to obtain an airtight connection, i.e. the compartment is sealed and exchange of fluids is possible only via said whole 14. The wall may be attached to the bottom e.g. by welding or boding, in particular by induction welding.

An injection pipe 16 is connected by welding or bonding to the opening 14. The other end of the pipe 16 is connected via a valve to a vacuum pump via tube 19 and the compartment of the cooking pot is evacuated to at least 104 Pa. Now, the fluid communication of the tube 19 and the pipe 16 is closed by the valve. Instead the compartment is connected to a container 20 (e.g. a beaker) with the coating liquid 30 until a predefined amount of the coating liquid 30 is sucked into the compartment. For an compartment having a diameter of 30 cm and height of 1 cm m one should add about 800 ml of the coating liquid. The connection between the container 20 and the pipe 16 is disconnected using the valve and the compartment is again evacuated to at least 104 Pa by connecting the tube 19 with the pipe 16 using the valve. Subsequently the compartment of the rod 10 is sealed for example by clamping or welding the pipe, if possible close to the disc 12. This is symbolized in the detail by arrows. Subsequently the cooking pot should be heated.

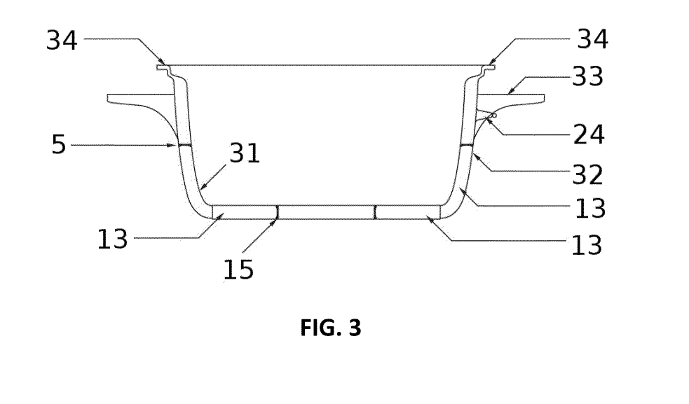

FIG. 3 shows a further cooking pot example. In this example, not only the bottom, but as well the wall 5 has a double layer structure, i.e. bottom and wall enclose a compartment 13. The compartment 13 may be manufactured by adding an inner shell 31 and an outer shell 32, which are connected by e.g. welding at their respective upper rims 34. To enhance rigidity, supports 15 may be positioned between the two shells 31, 32. The compartment 13 be-tween the inner shell 31 and the outer shell 32 is preferably coated with inorganic salts, in particular a coating liquid as prepared according to FIG. 1. The coating procedure is similar to the procedure as explained with regard to FIG. 2. The later inner surfaces of the two shells 31, 32 should be cleaned, prior to mounting them to form the cooking pot. For ease of coating the cooking pot has an inlet 24 to which a pipe like 16 can be attached. As already explained above in more detail, the compartment 13 is evacuated, a corresponding amount of coating liquid is filled in the compartment, the compartment may be evacuated again and is subsequently closed. Closing of the inlet 24 is rather simple as it is hidden behind a handle after mounting of the handle. This means, the handle is preferably mounted after closing the inlet 24. Like the cooking pot of FIG. 2 the cooking pot should be heated after the inlet 24 was closed, to ensure that the water evaporates and the inorganic compounds of the coating liquid attach to the inner surfaces of the compartment 13.

It will be appreciated to those skilled in the art having the benefit of this disclosure that this invention is believed to provide an improved cooking pot. Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

### LIST OF REFERENCE NUMERALS

1 cooking pot
5 cooking pot wall
10 spacer
11 upper disc
12 lower disc
13 compartment
14 opening
15 support structure
16 pipe
18 tube to container 30 with coating liquid 20
19 tube to vacuum pump
20 container (e.g. beaker)
30 coating liquid
31 inner shell
32 outer shell
33 handle
34 rim

1. Cooking pot comprising:
a bottom, to which a wall structure is attached to thereby form a space for heating food, wherein:
the bottom has at least two layers that are spaced by at least one spacer to define a closed hollow compartment inside the bottom,
an inorganic salt coating at least a portion of inner surfaces of the bottom that define the hollow compartment, and
the hollow compartment is evacuated.

2. Cooking pot of claim 1, wherein
the bottom comprises:
an upper disc,
a lower disc, and
a ring like spacer positioned between the upper and lower discs to define the compartment.

3. Cooking pot of claim 1 wherein
the compartment is defined between an outer shell having a rim and an inner shell having a rim connected to the rim of the outer shell.

4. Cooking pot of claim 3, wherein
each of the outer and inner shells has a bottom region and a wall region, the wall regions of the outer and inner shells define the cooking pot's wall structure, and the bottom regions of the outer and inner shells define the cooking pot's bottom.

5. Cooking pot of claim 1,
wherein the coating was formed on the inner surface by inserting an amount of an aqueous solution into the compartment prior to closing it, the aqueous solution comprising at least a heat transfer agent, said heat transfer agent comprising, per 100 ml of aqueous solution, at least:

| | | | |
|---|---|---|---|
| Sodium dichromate | Na₂Cr₂O₇ | 0.15-0.25 | g |
| Silver dichromate | Ag₂Cr₂O₇ | 0.0005-0.0015 | g |
| Potassium | K₂Cr₂O₇ | 0.55-0.85 | g |
| dichromate | | | |

and gasifying the water part of the aqueous solution.

6. Cooking pot of claim 5,
wherein the aqueous solution comprises at least a passivation agent, the passivation agent comprising, per 100 ml of aqueous solution, at least:

| | | | |
|---|---|---|---|
| Sodium peroxide | Na₂O₂ | 0.08-0.2 | g |
| Beryllium oxide | BeO | 0.005-0.02 | g |
| Potassium | K₂Cr₂O₇ | 0.1-0.3 | g |
| dichromate | | | |
| Calcium dichromate | CaCr₂O₇•3H₂O | 0.1-0.3 | g |
| Boron oxide | B₂O₃ | 0.05-0.15 | g |

7. Cooking pot of claim 6,
wherein the aqueous solution comprises at least an excitement agent, the excitement agent comprising, per 100 ml of aqueous solution, at least:

| | | | |
|---|---|---|---|
| Cobaltous oxide | Co₂O₃ | 0.0005-0.0015 | g |
| Strontium chromate | SrCrO₄ | 0.05-0.15 | g |
| Potassium | K₂Cr₂O₇ | 0.55-0.65 | g |
| dichromate | | | |

8. Method for preparing an aqueous solution comprising at least an excitement agent that comprises, per 100 ml of aqueous solution, at least:

| | | | |
|---|---|---|---|
| Cobaltous oxide | Co₂O₃ | 0.0005-0.0015 | g |
| Strontium chromate | SrCrO₄ | 0.05-0.15 | g |
| Potassium | K₂Cr₂O₇ | 0.55-0.65 | g |
| dichromate | | | |

the method comprising:
dissolving in the given order and one after the other the ingredients of the passivation agent in ultra pure water and, after adding each ingredient to the water, stirring the water for at least 10 minutes;
after adding all ingredients of the passivation agent, stirring for at least 20 minutes;
dissolving, in the given order and one after the other, the ingredients of the excitation agent into the water and, after adding each ingredient to the water, stirring the water for at least 5 min.
dissolving all ingredients of the heat transfer agent, one after the other and in the given order, to the solution under continuous stirring.

9. Method for coating the inner surface of a cooking pot comprising:
a bottom, to which a wall structure is attached to thereby form a space for heating food, wherein
the bottom has at least two layers that are spaced by at least one spacer to define a closed hollow compartment inside the bottom,
an inorganic salt coating at least a portion of inner surfaces of the bottom that define the hollow compartment, and
the hollow compartment is evacuated;
the method comprising:
evacuating the compartment to a pressure at least as low as 10⁴ Pa,
connecting the evacuated compartment with a container comprising the aqueous solution of claim 5, and bringing the container in fluid communication with the compartment to thereby draw the fluid of the container and into the compartment,
evacuating the compartment to at least 10⁴ Pa, and
closing the compartment.

10. Method according to claim 9, wherein the aqueous solution comprises the aqueous solution of claim 6.

11. Method according to claim 9, wherein the aqueous solution comprises the aqueous solution of claim 7.

12. Method according to claim 9, wherein the aqueous solution comprises the aqueous solution of claim 5.
